(19) United States
(12) Patent Application Publication
(10) Pub. No.: US 2017/0084995 A1
(43) Pub. Date: Mar. 23, 2017

(54) ARRAY ANTENNA CALIBRATION METHOD, APPARATUS, AND SYSTEM

(71) Applicant: Huawei Technologies Co., Ltd., Shenzhen (CN)

(72) Inventor: Chenqing YANG, Chengdu (CN)

(21) Appl. No.: 15/370,863

(22) Filed: Dec. 6, 2016

Related U.S. Application Data
(63) Continuation of application No. PCT/CN2014/079360, filed on Jun. 6, 2014.

(51) Int. Cl. H01Q 3/26

(52) U.S. Cl. CPC H01Q 3/267

(57) ABSTRACT

Embodiments of the present disclosure provide an array antenna calibration method, apparatus, and system. The array antenna calibration method provided in the present disclosure includes: determining an intra-group calibration coefficient of a path in each array element group of an array antenna in a wireless air interface coupling calibration manner, where array elements of the array antenna are divided into at least two array element groups, and the path is corresponding to one or more array elements of the array antenna; determining an inter-group calibration coefficient of the path in each array element group in a wired coupling calibration manner; and determining a calibration coefficient of the array elements of the array antenna according to the intra-group calibration coefficient and the inter-group calibration coefficient, and compensating the array elements of the array antenna according to the calibration coefficient.

### CROSS-REFERENCE TO RELATED APPLICATIONS

This application is a continuation of International Application No. PCT/CN2014/079360, filed on Jun. 6, 2014, the disclosure of which is hereby incorporated by reference in its entirety.

### TECHNICAL FIELD

Embodiments of the present disclosure relate to communications technologies, and in particular, to an array antenna calibration method, apparatus, and system.

### BACKGROUND

In a large-scale array antenna system, to ensure a system gain brought by a beamforming technology, and take full advantage of a high spatial resolution capability brought by a large antenna array, consistency of responses on a receive path and a transmit path on a base station side needs to be ensured, where the response includes an amplitude and a phase. Four antennas or eight antennas are deployed in a base station in an existing Long Term Evolution (LTE) system, but a quantity of antennas in a base station in the large-scale array antenna system increases to several hundreds or even more. High-precision calibration needs to be performed on the receive path and the transmit path, to enable that a beam formed in space by the large antenna array for a user in a function of precoding or a steering vector becomes extremely narrow, and also enable the beam to more precisely point to the user to enhance signal received power of the user and reduce interference between matching users and between cells. Generally, wired coupling calibration or wireless air interface coupling calibration may be used for array antenna calibration, that is, a calibration signal is transmitted into or out of a to-be-calibrated path by using a wired cable or an air interface, and a calibration parameter is acquired by comparing amplitude phase characteristic differences between paths.

However, as the large-scale array antenna system is applied, a disadvantage of a conventional array antenna calibration method becomes increasingly apparent. A wired coupling calibration manner is limited by implementation difficulty and complexity that are caused when a quantity of ports in a coupling disk sharply increases, and a wireless air interface coupling calibration manner is limited by poor air interface stability and an expanded dynamic range that are caused by an increased array area. Neither the wired coupling calibration nor the wireless air interface coupling calibration can meet calibration precision in the large-scale array antenna system.

### SUMMARY

Embodiments of the present disclosure provide an array antenna calibration method, apparatus, and system, so as to improve calibration precision in a large-scale array antenna system.

According to a first aspect, an embodiment of the present disclosure provides an array antenna calibration method, including:

determining an intra-group calibration coefficient of a path in each array element group of an array antenna in a wireless air interface coupling calibration manner, where array elements of the array antenna are divided into at least two array element groups, and the path is corresponding to one or more array elements of the array antenna;

determining an inter-group calibration coefficient of the path in each array element group in a wired coupling calibration manner; and

determining a calibration coefficient of the array elements of the array antenna according to the intra-group calibration coefficient and the inter-group calibration coefficient, and compensating the array elements of the array antenna according to the calibration coefficient.

With reference to the first aspect, in a first possible implementation manner of the first aspect, determining an intra-group calibration coefficient of a path in any array element group in the wireless air interface coupling calibration manner includes:

determining a reference path in the array element group, where the reference path is any path in the array element group;

determining that an intra-group calibration coefficient of the reference path is 1;

determining a ratio of a response characteristic of another path, except the reference path, in the array element group to a response characteristic of the reference path in the wireless air interface coupling calibration manner; and

determining an intra-group calibration coefficient of the another path, except the reference path, in the array element group according to the ratio.

With reference to the first possible implementation manner of the first aspect, in a second possible implementation manner of the first aspect, the determining an inter-group calibration coefficient of the path in each array element group in a wired coupling calibration manner includes:

determining a response characteristic of a reference path in each array element group in the wired coupling calibration manner; and

determining the inter-group calibration coefficient according to the response characteristic of the reference path in each array element group.

With reference to the first or second possible implementation manner of the first aspect, in a third possible implementation manner of the first aspect, when the path is a transmit path, the determining a ratio of a response characteristic of another path, except the reference path, in the array element group to a response characteristic of the reference path in the wireless air interface coupling calibration manner includes:

determining a response characteristic of an air interface between a path in the array element group and an intra-group calibration receive path;

sending a first calibration signal to the intra-group calibration receive path by using the path in the array element group;

determining a response characteristic of the path in the array element group according to the received first calibration signal and the determined response characteristic of the air interface by using the intra-group calibration receive path; and

determining the ratio of the response characteristic of the another path, except the reference path, in the array element group to the response characteristic of the reference path.

With reference to the third possible implementation manner of the first aspect, in a fourth possible implementation manner of the first aspect, the determining an inter-group calibration coefficient of the reference path in each array element group in a wired coupling calibration manner includes:

sending a second calibration signal to an inter-group calibration receive path by using the reference path in each array element group;

determining the response characteristic of the reference path in each array element group according to the received second calibration signal by using the inter-group calibration receive path; and

determining the inter-group calibration coefficient according to the response characteristic of the reference path in each array element group.

With reference to the first or second possible implementation manner of the first aspect, in a fifth possible implementation manner of the first aspect, when the path is a receive path, the determining a ratio of a response characteristic of another path, except the reference path, in the array element group to a response characteristic of the reference path in the wireless air interface coupling calibration manner includes:

determining a response characteristic of an air interface between a path in the array element group and an intra-group calibration transmit path;

receiving, by using the path in the array element group, a third calibration signal sent by the intra-group calibration transmit path;

determining a response characteristic of the path in the array element group according to the received third calibration signal and the determined response characteristic of the air interface by using the path in the array element group; and

determining the ratio of the response characteristic of the another path, except the reference path, in the array element group to the response characteristic of the reference path.

With reference to the fifth possible implementation manner of the first aspect, in a sixth possible implementation manner of the first aspect, the determining an inter-group calibration coefficient of the reference path in each array element group in a wired coupling calibration manner includes:

receiving, by using the reference path in each array element group, a fourth calibration signal sent by an inter-group calibration transmit path;

determining the response characteristic of the reference path in each array element group according to the received fourth calibration signal by using the reference path in each array element group; and

determining the inter-group calibration coefficient according to the response characteristic of the reference path in each array element group.

According to a second aspect, an embodiment of the present disclosure provides an array antenna calibration apparatus, including:

an intra-group processing module, configured to determine an intra-group calibration coefficient of a path in each array element group of an array antenna in a wireless air interface coupling calibration manner, where array elements of the array antenna are divided into at least two array element groups, and the path is corresponding to one or more array elements of the array antenna;

an inter-group processing module, configured to determine an inter-group calibration coefficient of the path in each array element group in a wired coupling calibration manner; and

an integrated processing module, configured to determine a calibration coefficient of the array elements of the array antenna according to the intra-group calibration coefficient and the inter-group calibration coefficient, and compensate the array elements of the array antenna according to the calibration coefficient.

With reference to the second aspect, in a first possible implementation manner of the second aspect, the intra-group processing module includes:

a reference path determining unit, configured to determine a reference path in any array element group, where the reference path is any path in the array element group.

a reference coefficient determining unit, configured to determine that an intra-group calibration coefficient of the reference path is 1;

a ratio determining unit, configured to determine a ratio of a response characteristic of another path, except the reference path, in the array element group to a response characteristic of the reference path in the wireless air interface coupling calibration manner; and

an intra-group calibration coefficient determining unit, configured to determine an intra-group calibration coefficient of the another path, except the reference path, in the array element group according to the ratio.

With reference to the second aspect or the first possible implementation manner of the second aspect, in a second possible implementation manner of the second aspect, the inter-group processing module is specifically configured to determine a response characteristic of a reference path in each array element group in the wired coupling calibration manner; and determine the inter-group calibration coefficient according to the response characteristic of the reference path in each array element group.

With reference to the first or second possible implementation manner of the second aspect, in a third possible implementation manner of the second aspect, when the path is a transmit path, the ratio determining unit is specifically configured to determine a response characteristic of an air interface between a path in the array element group and an intra-group calibration receive path; send a first calibration signal to the intra-group calibration receive path by using the path in the array element group; determine a response characteristic of the path in the array element group according to the received first calibration signal and the determined response characteristic of the air interface by using the intra-group calibration receive path; and determine the ratio of the response characteristic of the another path, except the reference path, in the array element group to the response characteristic of the reference path.

With reference to the third possible implementation manner of the second aspect, in a fourth possible implementation manner of the second aspect, the inter-group processing module is specifically configured to send a second calibration signal to an inter-group calibration receive path by using the reference path in each array element group; determine the response characteristic of the reference path in each array element group according to the received second calibration signal by using the inter-group calibration receive path; and determine the inter-group calibration coefficient according to the response characteristic of the reference path in each array element group.

With reference to the first or second possible implementation manner of the second aspect, in a fifth possible implementation manner of the second aspect, when the path is a receive path, the ratio determining unit is specifically configured to determine a response characteristic of an air interface between a path in the array element group and an intra-group calibration transmit path; receive, by using the path in the array element group, a third calibration signal sent by the intra-group calibration transmit path; determine a response characteristic of the path in the array element group according to the received third calibration signal and the determined response characteristic of the air interface by using the path in the array element group; and determine the ratio of the response characteristic of the another path, except the reference path, in the array element group to the response characteristic of the reference path.

With reference to the fifth possible implementation manner of the second aspect, in a sixth possible implementation manner of the second aspect, the inter-group processing module is specifically configured to receive, by using the reference path in each array element group, a fourth calibration signal sent by an inter-group calibration transmit path; determine the response characteristic of the reference path in each array element group according to the received fourth calibration signal by using the reference path in each array element group; and determine the inter-group calibration coefficient according to the response characteristic of the reference path in each array element group.

According to a third aspect, an embodiment of the present disclosure provides a transmit path calibration system, including: an inter-group unit, an integrated calculator, and multiple intra-group units, where the intra-group unit includes multiple array elements of an array antenna, a coupler, a transmitter circuit, a digital-to-analog converter DAC, an analog-to-digital converter ADC, a signal generator, an intra-group receiver circuit, and an intra-group calibration coefficient calculator; and the inter-group unit includes a combiner, an inter-group receiver circuit, an ADC, and an inter-group calibration coefficient calculator; where

the intra-group unit is configured to acquire intra-group calibration coefficients of all transmit paths in an array element group in a wireless air interface coupling calibration manner, where the transmit path is corresponding to one or more of the array elements in the array element group;

the inter-group unit is configured to acquire an inter-group calibration coefficient corresponding to each array element group in a wired coupling calibration manner; and

the integrated calculator is configured to acquire calibration coefficients of all transmit paths in the array antenna according to the intra-group calibration coefficient and the inter-group calibration coefficient, and compensate all the transmit paths in the array antenna according to the calibration coefficient, where all the transmit paths in the array antenna include all transmit paths in all array element groups.

According to a fourth aspect, an embodiment of the present disclosure provides a receive path calibration system, including: an inter-group unit, an integrated calculator, and multiple intra-group units, where the intra-group unit includes multiple array elements of an array antenna, a coupler, a receiver circuit, an analog-to-digital converter ADC, a digital-to-analog converter DAC, a signal generator, an intra-group transmitter circuit, an intra-group calibration coefficient calculator, and a receiving compensator; and the inter-group unit includes a divider, an inter-group transmitter circuit, a DAC, a signal generator, and an inter-group calibration coefficient calculator; where

the intra-group unit is configured to acquire intra-group calibration coefficients of all receive paths in an array element group in a wireless air interface coupling calibration manner, where the receive path is corresponding to one or more of the array elements in the array element group;

the inter-group unit is configured to acquire an inter-group calibration coefficient corresponding to each array element group in a wired coupling calibration manner; and

the integrated calculator is configured to acquire calibration coefficients of all receive paths in the array antenna according to the intra-group calibration coefficient and the inter-group calibration coefficient, and compensate all the receive paths in the array antenna according to the calibration coefficient, where all the receive paths in the array antenna include all receive paths in all array element groups.

According to the array antenna calibration method, apparatus, and system in the embodiments of the present disclosure, array elements of an array antenna are grouped according to a preset rule, an intra-group calibration coefficient and an inter-group calibration coefficient are separately acquired, then a calibration coefficient corresponding to each path in the array antenna is acquired according to the two coefficients, and each path is compensated according to the calibration coefficient, which improves calibration precision in a large-scale array antenna system.

### BRIEF DESCRIPTION OF DRAWINGS

To describe the technical solutions in the embodiments of the present disclosure more clearly, the following briefly describes the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a flowchart of Embodiment 1 of an array antenna calibration method according to the present disclosure;

FIG. 2 is a schematic diagram of grouping an array antenna;

FIG. 3 is a schematic diagram of a wireless air interface coupling calibration manner;

FIG. 4A is a schematic diagram of a transmit path in wired coupling calibration;

FIG. 4B is a schematic diagram of a receive path in wired coupling calibration;

FIG. 5 is a flowchart of Embodiment 2 of an array antenna calibration method according to the present disclosure;

FIG. 6 is a schematic structural diagram of Embodiment 1 of an array antenna calibration apparatus according to the present disclosure;

FIG. 7 is a schematic structural diagram of Embodiment 2 of an array antenna calibration apparatus according to the present disclosure;

FIG. 8 is a schematic structural diagram of an embodiment of a transmit path calibration system according to the present disclosure; and

FIG. 9 is a schematic structural diagram of an embodiment of a receive path calibration system according to the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

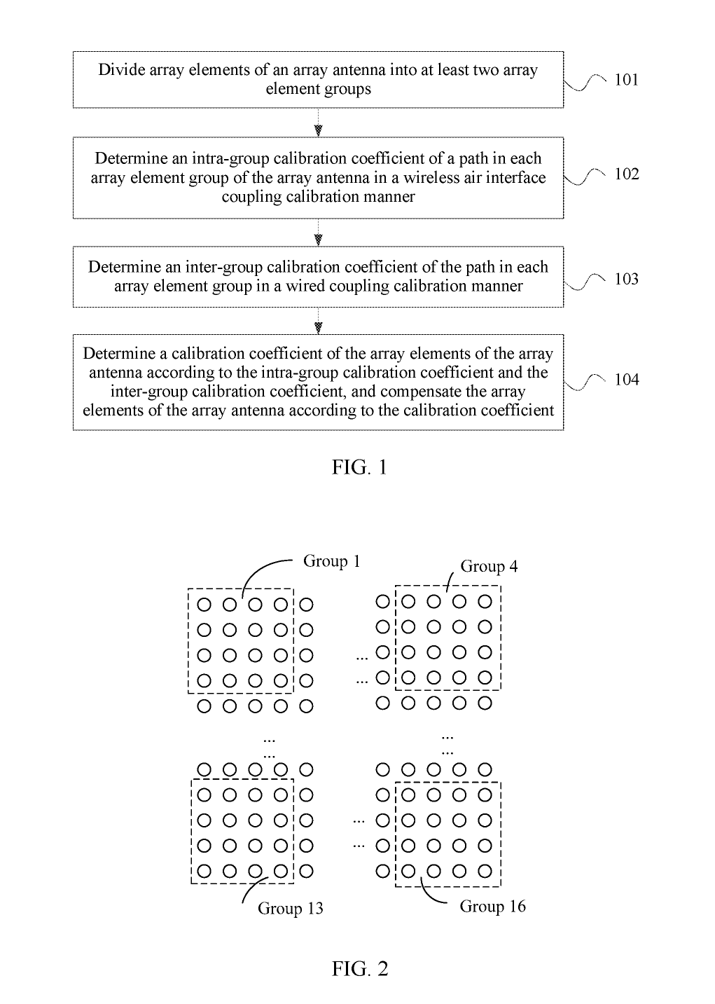

FIG. 1 is a flowchart of Embodiment 1 of an array antenna calibration method according to the present disclosure. As shown in FIG. 1, the method in this embodiment may include:

Step 101: Divide array elements of an array antenna into at least two array element groups.

In this embodiment, for calibration of a large-scale array antenna, array elements (that is, antenna elements) of the array antenna may be grouped according to a preset rule, where the preset rule may include a relative position of an array element in an antenna array, a coupling degree between array elements, array element signal received power, calibration signal detection precision, and the like. For example, FIG. 2 is a schematic diagram of grouping an array antenna. As shown in FIG. 2, the array antenna is formed by a 16×16 evenly distributed rectangular plane array, where each circle represents an array element, and array elements included in a dotted box form an array element group, that is, each array element group includes a 4×4 array of array elements, which is grouped according to positions of the array elements in the antenna array, and there are 16 groups in total. The array elements of the array antenna are grouped according to any one or a combination of the foregoing multiple rules, and a grouping method needs to ensure that calibration precision of paths in a same array element group meets a requirement of a large-scale array antenna system.

The foregoing step 101 is optional, because the array element group may be obtained by grouping by an antenna calibration apparatus or another device before the antenna is calibrated.

Step 102: Determine an intra-group calibration coefficient of a path in each array element group of the array antenna in a wireless air interface coupling calibration manner.

In this embodiment, the path is corresponding to one or more of the array elements in the array element group, and optionally, in the foregoing grouping process, that different array elements corresponding to a same path are added to a same array element group needs to be ensured. An array antenna calibration apparatus acquires intra-group calibration coefficients of all paths in each array element group in the wireless air interface coupling calibration manner. Because the large-scale array antenna has an extremely large quantity of array elements, and a quantity of array elements in each array group obtained after the grouping is reduced, when the wireless air interface coupling calibration manner is used for all array element groups obtained after the grouping, air interface stability can be ensured.

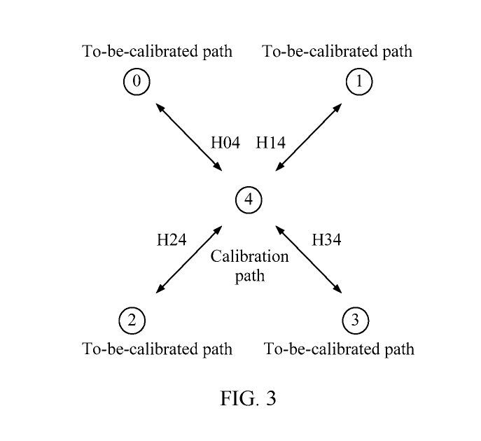

FIG. 3 is a schematic diagram of a wireless air interface coupling calibration manner. As shown in FIG. 3, in the wireless air interface coupling calibration manner, a wireless channel between array elements of the array antenna is used as a calibration signal transmission path, and all signal transmission between a to-be-calibrated path and a calibration path is implemented by using a wireless air interface channel. A double-headed arrow in FIG. 3 represents a wireless air interface channel between a to-be-calibrated path and a calibration path. Because a wireless air interface has relatively poor consistency, there is an extremely big error in response characteristics of air interfaces between a calibration path and each of to-be-calibrated paths 0, 1, 2, and 3. If no processing is performed, the error is directly reflected in a calibration result and affects system performance. To resolve this problem, before calibration is performed, a response characteristic of an air interface between each to-be-calibrated path and the calibration path needs to be acquired. A method for acquiring an air interface response characteristic may be: directly obtaining, by measurement, response characteristics of air interfaces between paths between two antennas, that is, H04, H14, H24, and H34 in FIG. 3, by using a test instrument such as a vector network analyzer. In the following calibration, the response characteristics of the air interfaces are used to eliminate inconsistency between wireless air interfaces. The method for acquiring an air interface response characteristic includes two types: off-line testing and on-line calculation. For transmit path calibration, calibration signals are separately sent to the calibration path by using the to-be-calibrated paths 0, 1, 2, and 3, and after the calibration signals are received by using the calibration path, a response characteristic corresponding to each to-be-calibrated path can be obtained by means of calculation. The response characteristic is formed by response characteristics of a transmit path, an air interface, and a receive path. Because receive paths (that is, the calibration path) corresponding to each transmit path are the same, and air interface response characteristics H04, H14, H24, and H34 are obtained, a response characteristic of a transmit path may be obtained after impact of an air interface response characteristic is removed from a response characteristic of each to-be-calibrated path, and then compensation is performed for transmit path inconsistency according to the response characteristic, that is, the transmit path calibration is implemented. For receive path calibration, calibration signals are sent to the to-be-calibrated paths by using the calibration path, and after the calibration signals are received by using the to-be-calibrated paths, a response characteristic corresponding to each to-be-calibrated path can be obtained by means of calculation. The response characteristic is formed by response characteristics of a transmit path, an air interface, and a receive path. Because transmit paths (that is, the calibration path) corresponding to each receive path are the same, and air interface response characteristics H04, H14, H24, and H34 are obtained, a response characteristic of a receive path may be obtained after impact of an air interface response characteristic is removed from a response characteristic of each to-be-calibrated path, and then compensation is performed for receive path inconsistency according to the response characteristic, that is, the receive path calibration is implemented.

Step 103: Determine an inter-group calibration coefficient of the path in each array element group in a wired coupling calibration manner.

In this embodiment, the wired coupling calibration manner is used between the array groups to acquire the inter-group calibration coefficient corresponding to each group. After the array elements of the antenna are grouped, a quantity of groups is limited, and calibration complexity of the large-scale array antenna is reduced. The inter-group calibration coefficient of each array element group may be acquired in the wired coupling calibration manner, and in this way, a wiring manner for wired coupling calibration may also be properly arranged, thereby improving calibration precision.

Steps 102 and 103 in this embodiment may be executed by an array antenna calibration apparatus, where the apparatus may be integrated in the array antenna as a dedicated calibration module, or may be a calibration device independent of the array antenna, and calibrate the array antenna by interacting with the array antenna by using an air interface or in a wired manner, which is not limited in the present disclosure.

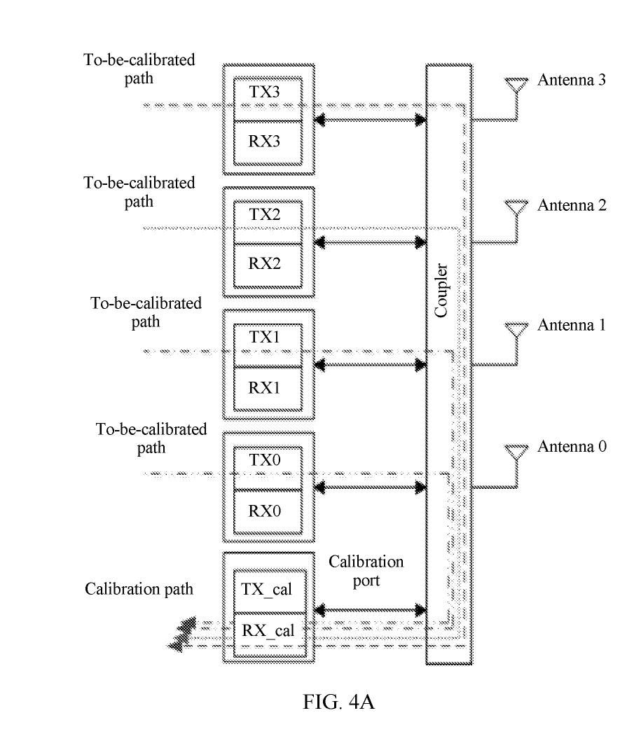

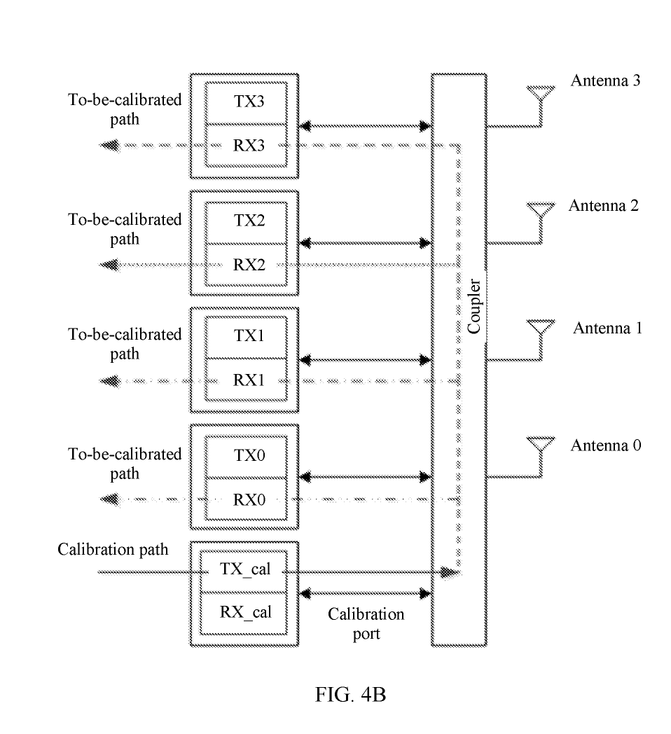

FIG. 4A is a schematic diagram of a transmit path in wired coupling calibration, and FIG. 4B is a schematic diagram of a receive path in wired coupling calibration. With reference to both FIG. 4A and FIG. 4B, wired coupling calibration refers to a method for connecting a to-be-calibrated path and a calibration path by using a wired manner, such as a coupling disk, as a calibration signal transmission path, and performing path calibration. In the figures, antennas requiring path calibration each include a transmit path (TX) and a receive path (RX). The calibration path is used to assist in calibration, and includes a transmit path (TX_cal) and a receive path (RX_cal). A to-be-calibrated path and a calibration path of the antenna are connected to the coupling disk by using a radio-frequency cable, where the calibration path is connected to a calibration port of the coupling disk, and the to-be-calibrated path is connected to a common port of the coupling disk. By using the coupling disk, a calibration signal sent by using the to-be-calibrated path can be received by using the calibration path, and a calibration signal sent by using the calibration path can also be received by using the to-be-calibrated path. The coupling disk requires high consistency on amplitude phase characteristics of various paths, that is, all paths, inside the coupling disk, passed by different to-be-calibrated paths are consistent. This property ensures calibration precision. For transmit path calibration, calibration signals are separately sent to the calibration path by using to-be-calibrated paths TX0, TX1, TX2, and TX3, and after the calibration signals are received by using the calibration path, a response characteristic corresponding to each to-be-calibrated path can be obtained by means of calculation. The response characteristic is formed by response characteristics of a transmit path, a coupling disk, and a receive path. Because all paths in the coupling disk are extremely consistent with each other, and receive paths (that is, the calibration path) corresponding to each transmit path are the same, inconsistency between the foregoing response characteristics may be considered to be caused by transmit path inconsistency, and compensation is performed for the transmit path inconsistency, that is, the transmit path calibration is implemented. For receive path calibration, calibration signals are separately sent to to-be-calibrated paths TX0, TX1, TX2, and TX3 by using the calibration path, and after the calibration signals are received by using the to-be-calibrated paths, a response characteristic corresponding to each to-be-calibrated path can be obtained by means of calculation. The response characteristic is formed by response characteristics of a transmit path, a coupling disk, and a receive path. Because all paths in the coupling disk are extremely consistent with each other, and transmit paths (that is, the calibration path) corresponding to each receive path are the same, inconsistency between the foregoing response characteristics may be considered to be caused by receive path inconsistency, and compensation is performed for the receive path inconsistency, that is, the receive path calibration is implemented.

Step 104: Determine a calibration coefficient of the array elements of the array antenna according to the intra-group calibration coefficient and the inter-group calibration coefficient, and compensate the array elements of the array antenna according to the calibration coefficient.

In this embodiment, all paths in the array antenna include all paths in all array element groups. According to the foregoing method, if an intra-group calibration coefficient and an inter-group calibration coefficient that are corresponding to each path in the array antenna are acquired, a final calibration coefficient of the path may be acquired according to the two coefficients. The array antenna calibration apparatus correspondingly compensates the path in the array antenna according to the calibration coefficient, so as to implement calibration of the path in the array antenna.

In this embodiment, array elements of an array antenna are grouped according to a preset rule, an intra-group calibration coefficient and an inter-group calibration coefficient are separately acquired, then a calibration coefficient corresponding to each path in the array antenna is acquired according to the two coefficients, and each path is compensated according to the calibration coefficient, which improves calibration precision in a large-scale array antenna system.

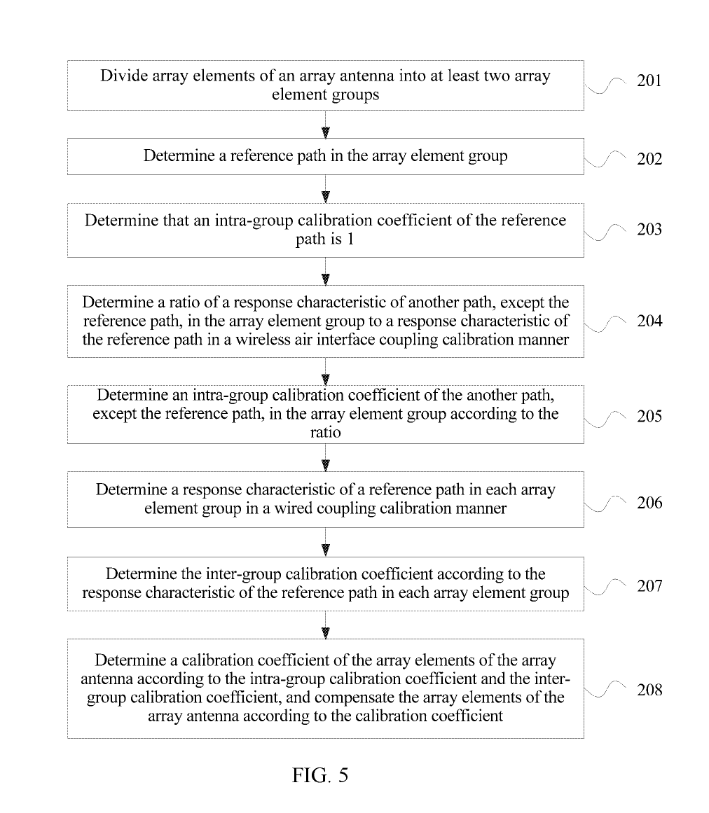

FIG. 5 is a flowchart of Embodiment 2 of an array antenna calibration method according to the present disclosure. As shown in FIG. 5, this embodiment is a calibration method for an array antenna transmit path, where the method may include:

Step 201: Divide array elements of an array antenna into at least two array element groups.

In this embodiment, a process of grouping the array elements of the array antenna according to a preset rule is similar to step 101 in the foregoing method embodiment, and details are not described herein.

The foregoing step 201 is optional, because the array element group may be obtained by grouping by an antenna calibration apparatus or another device before the antenna is calibrated.

Step 202: Determine a reference path in the array element group.

In this embodiment, the array element group may be any one of the at least two array element groups in step 101, where a wireless air interface coupling calibration manner is used in each array element group, and a wired coupling calibration manner is used between array element groups. In an inter-group calibration manner, a transmit path, that is, the reference path, is selected from each array element group as a representative to be calibrated. In an intra-group calibration manner, another transmit path uses the reference path as a reference, and calibration coefficients of these transmit paths are calculated relative to the reference path. It can be seen that an intra-group calibration coefficient is a relative value, which is relative to the reference path. However, the reference path may be any transmit path in the array element group, that is, there is no fixed rule for determining the reference path. In a unit of an array element group, the reference path may be any to-be-calibrated transmit path in the array element group.

Step 203: Determine that an intra-group calibration coefficient of the reference path is 1.

Step 204: Determine a ratio of a response characteristic of another path, except the reference path, in the array element group to a response characteristic of the reference path in a wireless air interface coupling calibration manner.

Step 205: Determine an intra-group calibration coefficient of the another path, except the reference path, in the array element group according to the ratio.

In this embodiment, using the reference path as a baseline path, an intra-group calibration coefficient is obtained relative to the reference path for other paths. For convenience, the intra-group calibration coefficient of the reference path is determined as 1.

According to a wireless air interface coupling calibration manner shown in FIG. 3, a response characteristic of an air interface between the transmit path in the array element group and an intra-group calibration receive path may be first determined. Then a first calibration signal is sent to the intra-group calibration receive path by using the transmit path in the array element group. A response characteristic of the transmit path in the array element group is determined according to the received first calibration signal and the determined response characteristic of the air interface by using the intra-group calibration receive path. The ratio of the response characteristic of the another path, except the reference path, in the array element group to the response characteristic of the reference path is determined.

An intra-group calibration receiver is disposed in each of the array element groups, where the intra-group calibration receiver is similar to a receiver corresponding to the calibration path shown in FIG. 3, and is configured to receive first calibration signals sent by all to-be-calibrated transmit paths in the array element groups. The first calibration signals are coupled to a receive path of the intra-group calibration receiver through a wireless air interface, and the intra-group calibration receiver inputs the received first calibration signals to an intra-group calculator. The intra-group calculator acquires, by means of calculation, the intra-group calibration coefficient of the another path, except the reference path, in the array element group according to the intra-group calibration coefficient 1 of the reference path and the foregoing ratio.

Step 206: Determine a response characteristic of a reference path in each array element group in a wired coupling calibration manner.

Step 207: Determine the inter-group calibration coefficient according to the response characteristic of the reference path in each array element group.

In this embodiment, according to a wired coupling calibration manner shown in FIG. 4A, a second calibration signal is sent to an inter-group calibration receive path by using the reference path in each array element group. The response characteristic of the reference path in each array element group is determined according to the received second calibration signal by using the inter-group calibration receive path. The inter-group calibration coefficient is determined according to the response characteristic of the reference path in each array element group.

An inter-group calibration receiver is disposed between array element groups, where the inter-group calibration receiver is similar to a receiver corresponding to the calibration path shown in FIG. 4A, and is configured to receive the second calibration signal sent by the determined reference path in each array element group. The second calibration signal is transmitted to a receive path of the inter-group calibration receiver by using a wired cable, and the inter-group calibration receiver inputs the received second calibration signal to an inter-group calculator. The inter-group calculator acquires, by means of calculation, an inter-group calibration coefficient of the reference path in each array element group.

Step 208: Determine a calibration coefficient of the array elements of the array antenna according to the intra-group calibration coefficient and the inter-group calibration coefficient, and compensate the array elements of the array antenna according to the calibration coefficient.

For example, it is assumed that the intra-group calibration coefficient is Taₖₚ, where k represents the k^{th} array element group, and p represents the p^{th} transmit path in the array element group. An air interface response characteristic that is of each transmit path relative to the reference path and that is obtained by means of calculation is Tmₖₚ. A sending characteristic of a reference channel is set to Tmₖᵣ=1, where r represents the reference channel. An intra-group calibration coefficient Taₖₚ of each transmit path in the array element group is obtained by using a formula Taₖₚ×Tmₖₚ=1.

It is assumed that the inter-group calibration coefficient is Tbₖ, where k represents the k^{th} array element group. A sending characteristic that is of the reference path in each array element group and that is obtained by means of calculation is Tnₖ. The inter-group calibration coefficient Tbₖ is obtained by using a formula Tbₖ×Tnₖ=1.

Combination of all transmit path calibration coefficients of the array antenna is implemented according to the foregoing intra-group calibration coefficient and the inter-group calibration coefficient, and a calibration coefficient Tcₖₚ of each transmit path is acquired, where k represents a number of an array element group, and p represents a number of a transmit path in the array element group. A calculation formula is Tcₖₚ=Taₖₚ×Tbₖ.

In this embodiment, array elements of an array antenna are grouped according to a preset rule, an intra-group calibration coefficient and an inter-group calibration coefficient of a transmit path are separately acquired, then a calibration coefficient corresponding to each transmit path in the array antenna is acquired according to the two coefficients, and each transmit path is compensated according to the calibration coefficient, which improves calibration precision in a large-scale array antenna system.

Further, the foregoing method embodiment may be further used for calibration for a receive path of the array antenna. A specific implementation method of determining a ratio of a response characteristic of another path, except the reference path, in the array element group to a response characteristic of the reference path in a wireless air interface coupling calibration manner in the foregoing step 204 may be: determining a response characteristic of an air interface between a path in the array element group and an intra-group calibration transmit path; receiving, by using the path in the array element group, a third calibration signal sent by the intra-group calibration transmit path; determining, by using the path in the array element group, a response characteristic of the path in the array element group according to the received third calibration signal and the determined response characteristic of the air interface; and determining the ratio of the response characteristic of the another path, except the reference path, in the array element group to the response characteristic of the reference path. A specific implementation method of determining a response characteristic of a reference path in each array element group in a wired coupling calibration manner and determining an inter-group calibration coefficient according to the response characteristic of the reference path in each array element group in the foregoing steps 206 to 207 may be: receiving, by using the reference path in each array element group, a fourth calibration signal sent by an inter-group calibration transmit path; determining, by using the reference path in each array element group, the response characteristic of the reference path in each array element group according to the received fourth calibration signal; and determining the inter-group calibration coefficient according to the response characteristic of the reference path in each array element group.

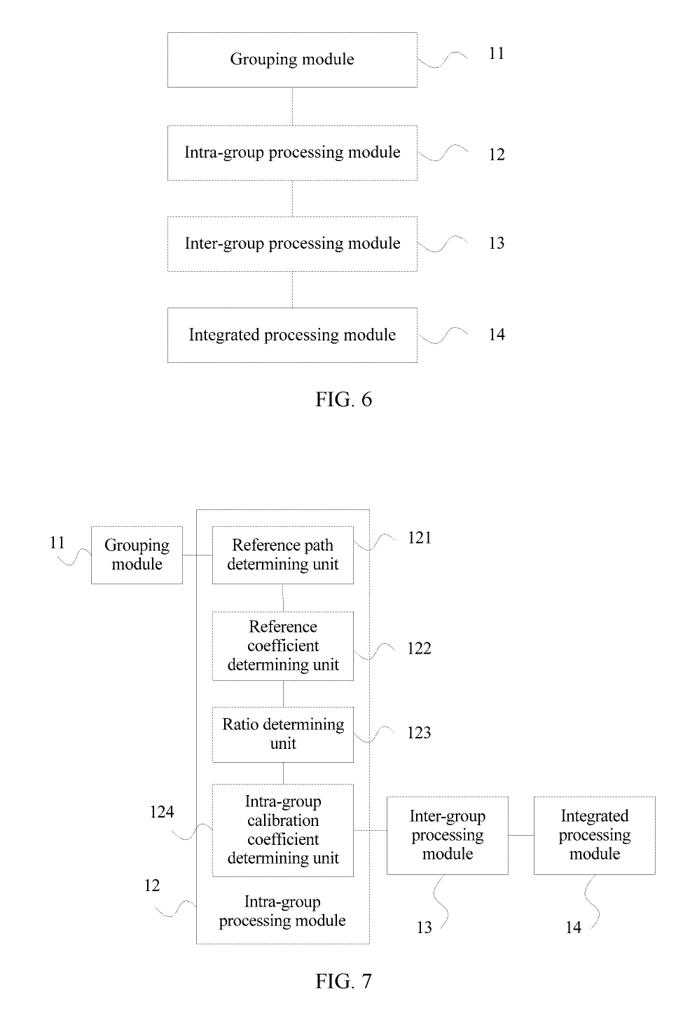

FIG. 6 is a schematic structural diagram of Embodiment 1 of an array antenna calibration apparatus according to the present disclosure. As shown in FIG. 6, the apparatus in this embodiment may include: a grouping module 11, an intra-group processing module 12, an inter-group processing module 13, and an integrated processing module 14, where the grouping module 11 is configured to divide array elements of an array antenna into at least two array element groups. The intra-group processing module 12 is configured to determine an intra-group calibration coefficient of a path in each array element group of the array antenna in a wireless air interface coupling calibration manner, where the path is corresponding to one or more array elements of the array antenna. The inter-group processing module 13 is configured to determine an inter-group calibration coefficient of the path in each array element group in a wired coupling calibration manner. The integrated processing module 14 is configured to determine a calibration coefficient of the array elements of the array antenna according to the intra-group calibration coefficient and the inter-group calibration coefficient, and compensate the array elements of the array antenna according to the calibration coefficient.

The foregoing grouping module 11 is optional, because the array element group may be obtained by grouping by an antenna calibration apparatus or another device before the antenna is calibrated.

The apparatus in this embodiment may be configured to execute the technical solution in the method embodiment shown in FIG. 1. Implementation principles and technical effects thereof are similar, and details are not described herein.

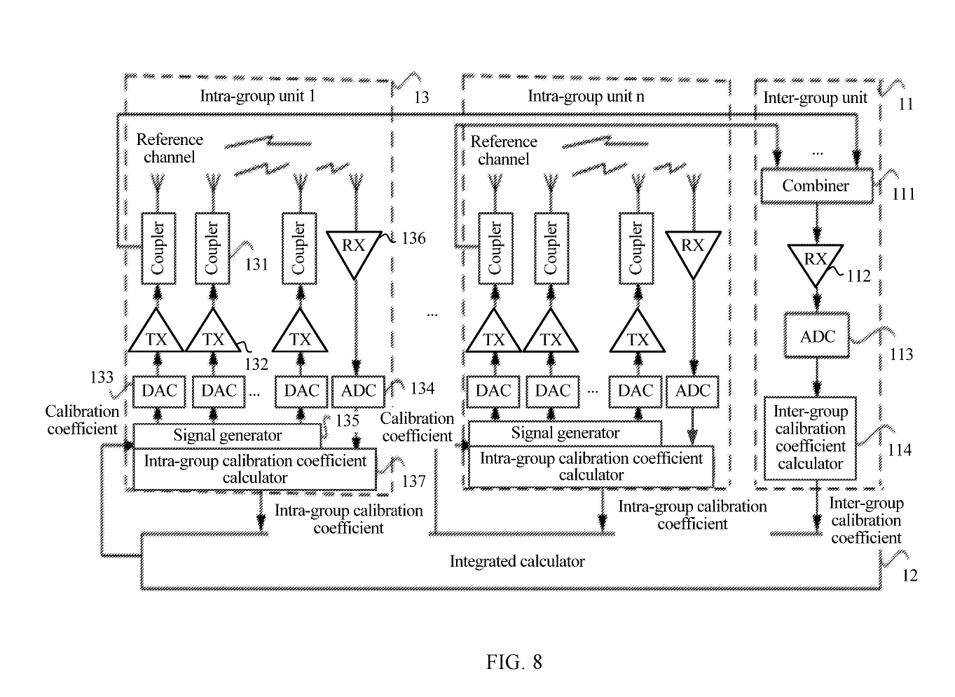

FIG. 7 is a schematic structural diagram of Embodiment 2 of an array antenna calibration apparatus according to the present disclosure. As shown in FIG. 7, the apparatus in this embodiment is based on a structure of the apparatus shown in FIG. 6. Further, the intra-group processing module 12 may include: a reference path determining unit 121, a reference coefficient determining unit 122, a ratio determining unit 123, and an intra-group calibration coefficient determining unit 124. The reference path determining unit 121 is configured to determine a reference path in any array element group, where the reference path is any path in the array element group. The reference coefficient determining unit 122 is configured to determine that an intra-group calibration coefficient of the reference path is 1. The ratio determining unit 123 is configured to determine a ratio of a response characteristic of another path, except the reference path, in the array element group to a response characteristic of the reference path in the wireless air interface coupling calibration manner. The intra-group calibration coefficient determining unit 124 is configured to determine an intra-group calibration coefficient of the another path, except the reference path, in the array element group according to the ratio. The inter-group processing module 13 is specifically configured to determine a response characteristic of a reference path in each array element group in the wired coupling calibration manner; and determine the inter-group calibration coefficient according to the response characteristic of the reference path in each array element group.

Further, when the path is a transmit path, the ratio determining unit 123 is specifically configured to determine a response characteristic of an air interface between a path in the array element group and an intra-group calibration receive path; send a first calibration signal to the intra-group calibration receive path by using the path in the array element group; determine a response characteristic of the path in the array element group according to the received first calibration signal and the determined response characteristic of the air interface by using the intra-group calibration receive path; and determine the ratio of the response characteristic of the another path, except the reference path, in the array element group to the response characteristic of the reference path. The inter-group processing module 13 is specifically configured to send a second calibration signal to an inter-group calibration receive path by using the reference path in each array element group; determine the response characteristic of the reference path in each array element group according to the received second calibration signal by using the inter-group calibration receive path; and determine the inter-group calibration coefficient according to the response characteristic of the reference path in each array element group.

Further, when the path is a receive path, the ratio determining unit 123 is specifically configured to determine a response characteristic of an air interface between a path in the array element group and an intra-group calibration transmit path; receive, by using the path in the array element group, a third calibration signal sent by the intra-group calibration transmit path; determine a response characteristic of the path in the array element group according to the received third calibration signal and the determined response characteristic of the air interface by using the path in the array element group; and determine the ratio of the response characteristic of the another path, except the reference path, in the array element group to the response characteristic of the reference path. The inter-group processing module 13 is specifically configured to receive, by using the reference path in each array element group, a fourth calibration signal sent by an inter-group calibration transmit path; determine the response characteristic of the reference path in each array element group according to the received fourth calibration signal by using the reference path in each array element group; and determine the inter-group calibration coefficient according to the response characteristic of the reference path in each array element group.

The apparatus in this embodiment may be configured to execute the technical solution in any method embodiment shown in FIG. 1 to FIG. 5. Implementation principles and technical effects thereof are similar, and details are not described herein.

FIG. 8 is a schematic structural diagram of an embodiment of a transmit path calibration system according to the present disclosure. As shown in FIG. 8, the system in this embodiment includes: an inter-group unit 11, an integrated calculator 12, and multiple intra-group units 13, where the intra-group unit 13 includes multiple array elements of an array antenna, a coupler 131, a transmitter circuit 132, a digital-to-analog converter (DAC) 133, an analog-to-digital converter (ADC) 134, a signal generator 135, an intra-group receiver circuit 136, and an intra-group calibration coefficient calculator 137. The inter-group unit 11 includes a combiner 111, an inter-group receiver circuit 112, an ADC 113, and an inter-group calibration coefficient calculator 114.

In any intra-group unit 13, the signal generator 135 is configured to generate a calibration signal. The DAC 133 in the intra-group unit is configured to convert the calibration signal into a to-be-sent analog signal. The transmitter circuit 132 is configured to perform filtering amplification processing on the to-be-sent analog signal and output a processed to-be-sent analog signal to the coupler 131. The coupler 131 is configured to divide the to-be-sent analog signal into two signals, where one signal is sent to the array antenna by using a straight-through port, and the other signal is sent to the inter-group receiver 112 circuit by using a coupling port. The intra-group receiver circuit 136 is configured to receive a calibration signal sent by using a transmit path in an array element group. The ADC 134 in the intra-group unit is configured to convert the calibration signal received by the intra-group receiver circuit 136 into a digital signal. The intra-group calibration coefficient calculator 137 is configured to determine an intra-group calibration coefficient according to the digital signal output by the ADC 134 in the intra-group unit. The combiner 111 is configured to combine calibration signals sent by using reference paths in at least two array element groups (the intra-group unit 13). The inter-group receiver circuit 112 is configured to receive a combined calibration signal. The ADC 113 in the inter-group unit is configured to convert the combined calibration signal into a digital signal. The inter-group calibration coefficient calculator 114 is configured to determine an inter-group calibration coefficient according to the digital signal output by the ADC 113 in the inter-group unit. The integrated calculator 12 is configured to acquire, by means of calculation, a calibration coefficient of the array elements of the array antenna according to the intra-group calibration coefficient and the inter-group calibration coefficient, and input the calibration coefficient to the signal generator 135, so that the signal generator 135 adjusts the generated digital signal according to the calibration coefficient and compensates the array elements of the array antenna.

The system in this embodiment may execute the technical solution in any method embodiment shown in FIG. 1 to FIG. 5. Implementation principles and technical effects thereof are similar, and details are not described herein.

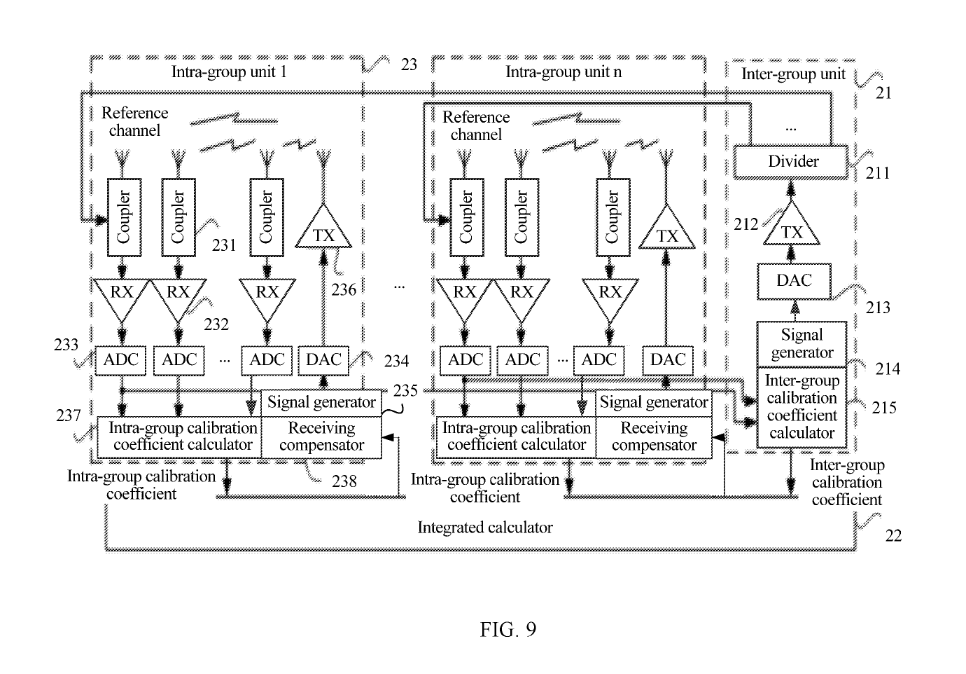

FIG. 9 is a schematic structural diagram of an embodiment of a receive path calibration system according to the present disclosure. As shown in FIG. 9, the system in this embodiment includes: an inter-group unit 21, an integrated calculator 22, and multiple intra-group units 23, where the intra-group unit 23 includes multiple array elements of an array antenna, a coupler 231, a receiver circuit 232, an ADC 233, a DAC 234, a signal generator 235, an intra-group transmitter circuit 236, an intra-group calibration coefficient calculator 237, and a receiving compensator 238. The inter-group unit 21 includes a divider 211, an inter-group transmitter circuit 212, a DAC 213, a signal generator 214, and an inter-group calibration coefficient calculator 215.

In any intra-group unit 23, the signal generator 235 in the intra-group unit is configured to generate a calibration signal within an array element group. The DAC 234 in the intra-group unit is configured to convert the calibration signal within the array element group into a to-be-sent analog signal. The intra-group transmitter circuit 236 is configured to send the to-be-sent analog signal to the coupler 231. The coupler 231 is configured to receive, by using a straight-through port, the to-be-sent analog signal sent by the intra-group transmitter circuit 236, and receive, by using a coupling port, an analog signal sent by the inter-group transmitter circuit 212. The receiver circuit 232 is configured to receive an analog signal. The ADC 233 in the intra-group unit is configured to convert the analog signal received by the receiver circuit 232 into a digital signal. The intra-group calibration coefficient calculator 237 is configured to determine an intra-group calibration coefficient according to the digital signal output by the ADC 233 in the intra-group unit. The signal generator 214 in the inter-group unit is configured to generate a calibration signal between array element groups. The DAC 213 in the inter-group unit is configured to convert the calibration signal between the array element groups into an analog signal. The inter-group transmitter circuit 212 is configured to send the analog signal to the divider 211. The divider 211 is configured to divide the analog signal into multiple calibration signals corresponding to array element groups, and input the divided analog signal into a reference path in an array element group. The inter-group calibration coefficient calculator 215 is configured to determine an inter-group calibration coefficient according to a digital signal output by an ADC of the reference path in the array element group. The integrated calculator 22 is configured to acquire, by means of calculation, a calibration coefficient of the array elements of the array antenna according to the intra-group calibration coefficient and the inter-group calibration coefficient, and input the calibration coefficient to the receiving compensator 238. The receiving compensator 238 is configured to adjust, according to the calibration coefficient, the digital signal generated by the signal generator 235 in the intra-group unit, and compensate the array elements of the array antenna.

The system in this embodiment may execute the technical solution in any method embodiment shown in FIG. 1 to FIG. 5. Implementation principles and technical effects thereof are similar, and details are not described herein.

In the several embodiments provided in the present disclosure, it should be understood that the disclosed apparatus and method may be implemented in other manners. For example, the described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, a network device, or the like) or a processor to perform a part of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

It may be clearly understood by a person skilled in the art that, for the purpose of convenient and brief description, division of the foregoing function modules is taken as an example for illustration. In an actual application, the foregoing functions can be allocated to different function modules and implemented according to a requirement, that is, an inner structure of an apparatus is divided into different function modules to implement all or part of the functions described above. For a detailed working process of the foregoing apparatus, reference may be made to a corresponding process in the foregoing method embodiments, and details are not described herein.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. An array antenna calibration method, comprising:
determining an intra-group calibration coefficient of a path in each array element group of an array antenna in a wireless air interface coupling calibration manner, wherein array elements of the array antenna are divided into at least two array element groups, and the path corresponds to one or more array elements of the array antenna;
determining an inter-group calibration coefficient of the path in each array element group in a wired coupling calibration manner; and
determining a first calibration coefficient of the array elements of the array antenna according to the intra-group calibration coefficient and the inter-group calibration coefficient, and compensating the array elements of the array antenna according to the first calibration coefficient.

2. The method according to claim 1, wherein determining the intra-group calibration coefficient of the path in any array element group in the wireless air interface coupling calibration manner comprises:
determining a reference path in the array element group, wherein the reference path is any path in the array element group;
determining that an intra-group calibration coefficient of the reference path is 1;
determining a ratio of a response characteristic of another path, except the reference path, in the array element group to a response characteristic of the reference path in the wireless air interface coupling calibration manner; and
determining an intra-group calibration coefficient of the another path, except the reference path, in the array element group according to the ratio.

3. The method according to claim 2, wherein the determining the inter-group calibration coefficient of the path in each array element group in a wired coupling calibration manner comprises:
determining a response characteristic of a reference path in each array element group in the wired coupling calibration manner; and
determining the inter-group calibration coefficient according to the response characteristic of the reference path in each array element group.

4. The method according to claim 3, wherein the path is a transmit path, and the determining the ratio of the response characteristic of another path, except the reference path, in the array element group to the response characteristic of the reference path in the wireless air interface coupling calibration manner comprises:
determining a response characteristic of an air interface between a path in the array element group and an intra-group calibration receive path;
sending a first calibration signal to the intra-group calibration receive path based on the path in the array element group;
determining a response characteristic of the path in the array element group according to the first calibration signal and the response characteristic of the air interface based on the intra-group calibration receive path; and
determining the ratio of the response characteristic of the another path, except the reference path, in the array element group to the response characteristic of the reference path.

5. The method according to claim 3, wherein the path is a receive path, and the determining the ratio of the response characteristic of another path, except the reference path, in the array element group to the response characteristic of the reference path in the wireless air interface coupling calibration manner comprises:
determining a response characteristic of an air interface between a path in the array element group and an intra-group calibration transmit path;
receiving, based on the path in the array element group, a third calibration signal sent by the intra-group calibration transmit path;
determining a response characteristic of the path in the array element group according to the third calibration signal and the response characteristic of the air interface based on the path in the array element group; and
determining the ratio of the response characteristic of the another path, except the reference path, in the array element group to the response characteristic of the reference path.

6. The method according to claim 2, wherein the path is a transmit path, and the determining the ratio of the response characteristic of another path, except the reference path, in the array element group to the response characteristic of the reference path in the wireless air interface coupling calibration manner comprises:
determining a response characteristic of an air interface between a path in the array element group and an intra-group calibration receive path;
sending a first calibration signal to the intra-group calibration receive path based on the path in the array element group;
determining a response characteristic of the path in the array element group according to the first calibration signal and the response characteristic of the air interface based on the intra-group calibration receive path; and
determining the ratio of the response characteristic of the another path, except the reference path, in the array element group to the response characteristic of the reference path.

7. The method according to claim 6, wherein the determining the inter-group calibration coefficient of the reference path in each array element group in the wired coupling calibration manner comprises:
sending a second calibration signal to an inter-group calibration receive path based on the reference path in each array element group;
determining the response characteristic of the reference path in each array element group according to the second calibration signal based on the inter-group calibration receive path; and
determining the inter-group calibration coefficient according to the response characteristic of the reference path in each array element group.

8. The method according to claim 2, wherein the path is a receive path, and the determining the ratio of the response characteristic of another path, except the reference path, in the array element group to the response characteristic of the reference path in the wireless air interface coupling calibration manner comprises:
determining a response characteristic of an air interface between a path in the array element group and an intra-group calibration transmit path;
receiving, based on the path in the array element group, a third calibration signal sent by the intra-group calibration transmit path;
determining a response characteristic of the path in the array element group according to the third calibration signal and the response characteristic of the air interface based on the path in the array element group; and
determining the ratio of the response characteristic of the another path, except the reference path, in the array element group to the response characteristic of the reference path.

9. The method according to claim 8, wherein the determining the inter-group calibration coefficient of the reference path in each array element group in the wired coupling calibration manner comprises:
receiving, based on the reference path in each array element group, a fourth calibration signal sent by an inter-group calibration transmit path;
determining the response characteristic of the reference path in each array element group according to the fourth calibration signal based on the reference path in each array element group; and
determining the inter-group calibration coefficient according to the response characteristic of the reference path in each array element group.

10. An array antenna calibration apparatus, comprising:
a processor; and
a memory storing a plurality of computer executable instructions thereon that, when executed by the processor, causes apparatus to:
determine an intra-group calibration coefficient of a path in each array element group of an array antenna in a wireless air interface coupling calibration manner, wherein array elements of the array antenna are divided into at least two array element groups, and the path is corresponding to one or more array elements of the array antenna;
determine an inter-group calibration coefficient of the path in each array element group in a wired coupling calibration manner; and
determine a first calibration coefficient of the array elements of the array antenna according to the intra-group calibration coefficient and the inter-group calibration coefficient, and compensate the array elements of the array antenna according to the first calibration coefficient.

11. The apparatus according to claim 10, wherein the memory further stores computer executable instructions that, when executed by the processor, further cause the apparatus to:
determine a reference path in any array element group, wherein the reference path is any path in the array element group;
determine that an intra-group calibration coefficient of the reference path is 1;
determine a ratio of a response characteristic of another path, except the reference path, in the array element group to a response characteristic of the reference path in the wireless air interface coupling calibration manner; and
determine an intra-group calibration coefficient of the another path, except the reference path, in the array element group according to the ratio.

12. The apparatus according to claim 11, wherein the memory further stores computer executable instructions that, when executed by the processor, further cause the apparatus to:
determine a response characteristic of a reference path in each array element group in the wired coupling calibration manner; and
determine the inter-group calibration coefficient according to the response characteristic of the reference path in each array element group.

13. The apparatus according to claim 12, wherein the path is a transmit path, and the memory further stores computer executable instructions that, when executed by the processor, further cause the apparatus to:
determine a response characteristic of an air interface between a path in the array element group and an intra-group calibration receive path;
send a first calibration signal to the intra-group calibration receive path based on the path in the array element group;
determine a response characteristic of the path in the array element group according to the first calibration signal and the response characteristic of the air interface based on the intra-group calibration receive path; and
determine the ratio of the response characteristic of the another path, except the reference path, in the array element group to the response characteristic of the reference path.

14. The apparatus according to claim 12, wherein the path is a receive path, and the memory further stores computer executable instructions that, when executed by the processor, further cause the apparatus to:
determine a response characteristic of an air interface between a path in the array element group and an intra-group calibration transmit path;
receive, based on the path in the array element group, a third calibration signal sent by the intra-group calibration transmit path;
determine a response characteristic of the path in the array element group according to the third calibration signal and the response characteristic of the air interface based on the path in the array element group; and
determine the ratio of the response characteristic of the another path, except the reference path, in the array element group to the response characteristic of the reference path.

15. The apparatus according to claim 11, wherein when the path is a transmit path, the memory further stores computer executable instructions that, when executed by the processor, further cause the apparatus to:
determine a response characteristic of an air interface between a path in the array element group and an intra-group calibration receive path;
send a first calibration signal to the intra-group calibration receive path based on the path in the array element group;
determine a response characteristic of the path in the array element group according to the first calibration signal and the response characteristic of the air interface based on the intra-group calibration receive path; and
determine the ratio of the response characteristic of the another path, except the reference path, in the array element group to the response characteristic of the reference path.

16. The apparatus according to claim 15, wherein the memory further stores computer executable instructions that, when executed by the processor, further cause the apparatus to:
send a second calibration signal to an inter-group calibration receive path based on the reference path in each array element group;
determine the response characteristic of the reference path in each array element group according to the second calibration signal based on the inter-group calibration receive path; and
determine the inter-group calibration coefficient according to the response characteristic of the reference path in each array element group.

17. The apparatus according to claim 11, wherein when the path is a receive path, the memory further stores computer executable instructions that, when executed by the processor, further cause the apparatus to:
determine a response characteristic of an air interface between a path in the array element group and an intra-group calibration transmit path;
receive, based on the path in the array element group, a third calibration signal sent by the intra-group calibration transmit path;
determine a response characteristic of the path in the array element group according to the third calibration signal and the response characteristic of the air interface based on the path in the array element group; and
determine the ratio of the response characteristic of the another path, except the reference path, in the array element group to the response characteristic of the reference path.

18. The apparatus according to claim 17, wherein the memory further stores computer executable instructions that, when executed by the processor, further cause the apparatus to:
receive, based on the reference path in each array element group, a fourth calibration signal sent by an inter-group calibration transmit path;
determine the response characteristic of the reference path in each array element group according to the fourth calibration signal based on the reference path in each array element group; and
determine the inter-group calibration coefficient according to the response characteristic of the reference path in each array element group.

19. A transmit path calibration system, comprising:
an inter-group unit comprising: a combiner, an inter-group receiver circuit, an analog-to-digital converter (ADC), and an inter-group calibration coefficient calculator;
an integrated calculator; and
an intra-group unit comprising: multiple array elements of an array antenna, a coupler, a transmitter circuit, a digital-to-analog converter (DAC), an ADC, a signal generator, an intra-group receiver circuit, and an intra-group calibration coefficient calculator;
wherein:
the signal generator is configured to generate a calibration signal;
the DAC in the intra-group unit is configured to convert the calibration signal into a to-be-sent analog signal;
the transmitter circuit is configured to perform filtering amplification processing on the to-be-sent analog signal and output a processed to-be-sent analog signal to the coupler;
the coupler is configured to divide the to-be-sent analog signal into two signals, wherein one signal is sent to the array antenna based on a straight-through port, and the other signal is sent to the inter-group receiver circuit based on a coupling port;
the intra-group receiver circuit is configured to receive a calibration signal sent based on a transmit path in an array element group;
the ADC in the intra-group unit is configured to convert the calibration signal received by the intra-group receiver circuit into a digital signal;
the intra-group calibration coefficient calculator is configured to determine an intra-group calibration coefficient according to the digital signal output by the ADC in the intra-group unit;
the combiner is configured to combine calibration signals sent based on reference paths in at least two array element groups;
the inter-group receiver circuit is configured to receive a combined calibration signal;
the ADC in the inter-group unit is configured to convert the combined calibration signal into a digital signal;
the inter-group calibration coefficient calculator is configured to determine an inter-group calibration coefficient according to the digital signal output by the ADC in the inter-group unit; and
the integrated calculator is configured to acquire, by means of calculation, a calibration coefficient of the array elements of the array antenna according to the intra-group calibration coefficient and the inter-group calibration coefficient, and input the calibration coefficient to the signal generator, so that the signal generator adjusts the generated digital signal according to the calibration coefficient and compensates the array elements of the array antenna.

20. A receive path calibration system, comprising:
an inter-group unit comprising: a divider, an inter-group transmitter circuit, a digital-to-analog converter (DAC), a signal generator, and an inter-group calibration coefficient calculator;
an integrated calculator; and
an intra-group unit comprising: multiple array elements of an array antenna, a coupler, a receiver circuit, an analog-to-digital converter (ADC), a digital-to-analog converter DAC, a signal generator, an intra-group transmitter circuit, an intra-group calibration coefficient calculator, and a receiving compensator;
wherein:
the signal generator in the intra-group unit is configured to generate a calibration signal within an array element group;
the DAC in the intra-group unit is configured to convert the calibration signal within the array element group into a to-be-sent analog signal;
the intra-group transmitter circuit is configured to send the to-be-sent analog signal to the coupler;
the coupler is configured to receive, based on a straight-through port, the to-be-sent analog signal sent by the intra-group transmitter circuit, and receive, based on a coupling port, an analog signal sent by the inter-group transmitter circuit;
the receiver circuit is configured to receive the analog signal;
the ADC in the intra-group unit is configured to convert the analog signal received by the receiver circuit into a digital signal;
the intra-group calibration coefficient calculator is configured to determine an intra-group calibration coefficient according to the digital signal output by the ADC in the intra-group unit;
the signal generator in the inter-group unit is configured to generate a calibration signal between array element groups;
the DAC in the inter-group unit is configured to convert the calibration signal between the array element groups into an analog signal;
the inter-group transmitter circuit is configured to send the analog signal to the divider;
the divider is configured to divide the analog signal into multiple calibration signals corresponding to array element groups, and input the divided analog signal into a reference path in an array element group;
the inter-group calibration coefficient calculator is configured to determine an inter-group calibration coefficient according to a digital signal output by an ADC of the reference path in the array element group;
the integrated calculator is configured to acquire, by means of calculation, a calibration coefficient of the array elements of the array antenna according to the intra-group calibration coefficient and the inter-group calibration coefficient, and input the calibration coefficient to the receiving compensator; and
the receiving compensator is configured to adjust, according to the calibration coefficient, the digital signal generated by the signal generator in the intra-group unit, and compensate the array elements of the array antenna.
